(19) United States
(12) Patent Application Publication
(10) Pub. No.: US 2011/0075437 A1
(43) Pub. Date: Mar. 31, 2011

(54) VEHICLE HEADLIGHT APPARATUS

(75) Inventor: Jiun-Jiang Wang, Tainan City (TW)

(73) Assignee: MAXZONE VEHICHLE LIGHTING CORP., Fontana, CA (US)

(21) Appl. No.: 12/570,372

(22) Filed: Sep. 30, 2009

(51) Int. Cl. B60Q 1/00

(52) U.S. Cl. 362/538

(57) ABSTRACT

A vehicle headlight apparatus includes a lamp device having an optical axis and generating light beams. A lens device has a plurality of lenses disposed in front of the lamp device. A reflector unit has a plurality of reflecting surfaces. Any two adjacent ones of the reflecting surfaces are spaced apart from each other along a transverse direction perpendicular to the optical axis. The reflecting surfaces reflect the light beams generated by the lamp device, and face respectively the lenses. The light beams reflected from each of the reflecting surfaces intersect at a focal point of a corresponding one of the lenses, and are subsequently transmitted into the lenses so that the light beams are parallel after they pass through the corresponding one of the lenses.

### BACKGROUND OF THE INVENTION

1. Field of the Invention

The invention relates to a vehicle headlight apparatus, more particularly to vehicle headlight apparatus capable of emitting parallel light beams.

2. Description of the Related Art

Referring to FIG. 1, a conventional vehicle headlight 1 disclosed in Taiwanese Patent Publication No. 1258549 comprises a main body 11, and a plurality of lamp devices 12 mounted on the main body 11. Each of the lamp devices 12 has an optical axis (X) (see FIG. 2), an LED lamp 121, a reflector 122, and a convex lens 123 disposed in front of the lamp device 121. The reflector 122 reflects light beams that are generated by the lamp device 121. The light beams reflected from the reflector 122 are transmitted into and refracted in the convex lens 123. However, since the brightness of the LED lamps 121 is insufficient, the conventional vehicle headlight 1 must employ a large number of the lamp devices 12 to satisfy illumination demand. Accordingly, the manufacturing cost of the conventional vehicle headlight 1 is increased.

Referring to FIG. 2, the convex lens 123 has a pair of first and second focal points (f, f′). Light beams generated by the LED lamp 121 that are parallel to the optical axis (X) are transmitted into and refracted in the lens 123. The refracted light beams are converged toward the second focal point (f′). In fact, once the light beams generated by the LED lamp 121 do not pass through the first focal point (f), the refracted light beams will be focused at some positions on the optical axis (X) including the second focal point (f′).

As a result, the refracted light beams cause discomforting glare for oncoming drivers.

### SUMMARY OF THE INVENTION

Therefore, the object of the invention is to provide a vehicle headlight apparatus capable of alleviating the above drawbacks of the prior art.

Accordingly, a vehicle headlight apparatus of the present invention comprises a lamp device having an optical axis and generating light beams. A lens device has a plurality of lenses disposed in front of the lamp device. A reflector unit has a plurality of reflecting surfaces. Any two adjacent ones of the reflecting surfaces are spaced apart from each other along a transverse direction perpendicular to the optical axis. The reflecting surfaces reflect the light beams generated by the lamp device, and face respectively the lenses. The light beams reflected from each of the reflecting surfaces intersect at a focal point of a corresponding one of the lenses, and are subsequently transmitted into the lenses so that the light beams are parallel after they pass through the corresponding one of the lenses.

### BRIEF DESCRIPTION OF THE DRAWINGS

Other features and advantages of the invention will become apparent in the following detailed description of the preferred embodiments with reference to the accompanying drawings, of which:

FIG. 1 is a partly exploded perspective view of a conventional vehicle headlight;

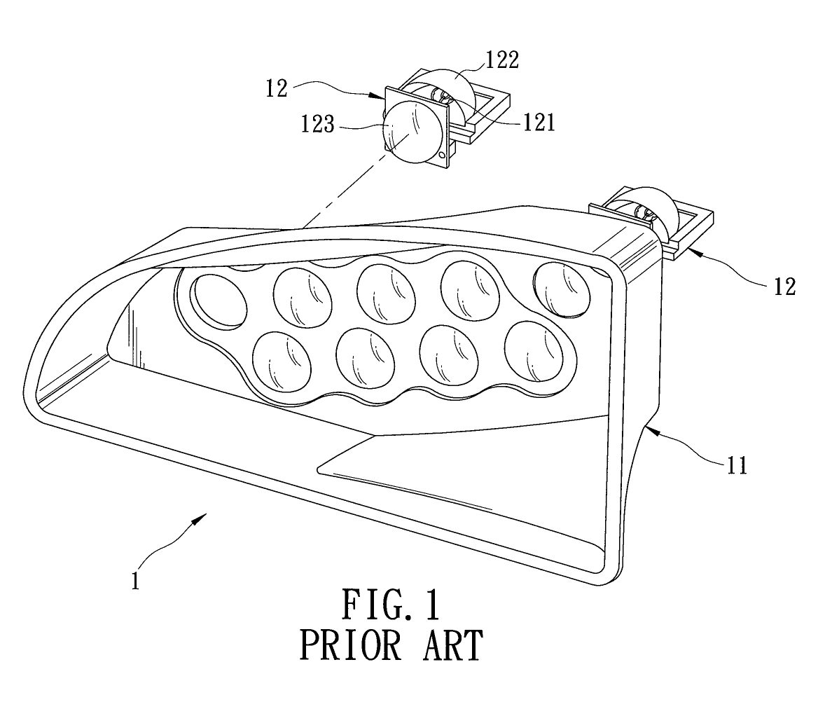

FIG. 2 is a schematic view of a convex lens of the conventional vehicle headlight, illustrating how the light beams generated by a lamp device are transmitted into and refracted in the convex lens;

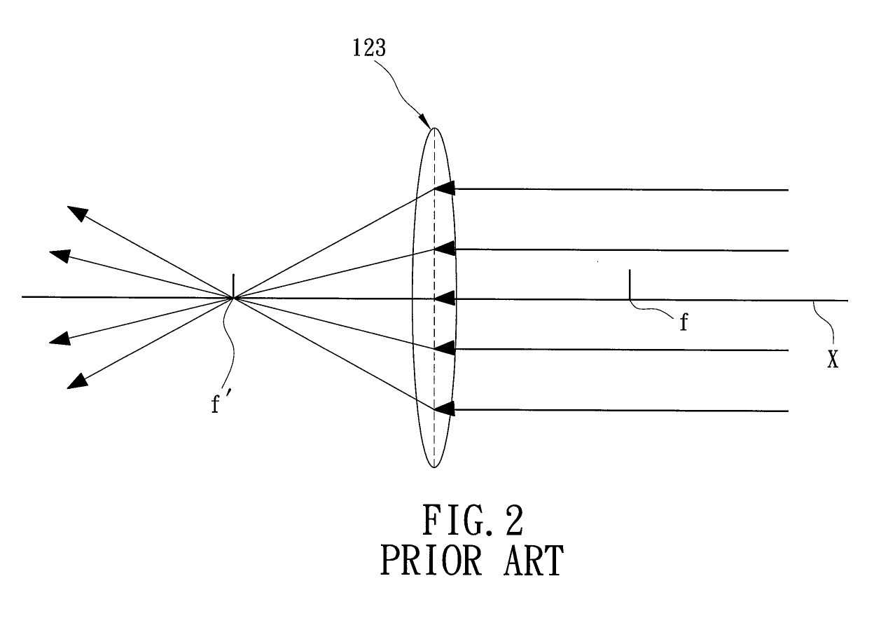

FIG. 3 is a perspective view of a vehicle headlight apparatus of a first preferred embodiment of the present invention;

FIG. 4 is a schematic sectional view of the vehicle headlight apparatus of the first preferred embodiment;

FIG. 5 is a schematic sectional view of a vehicle headlight apparatus of a second preferred embodiment according to the present invention;

FIG. 6 is a schematic sectional view of a vehicle headlight apparatus of a third preferred embodiment of the present invention; and

FIG. 7 is a schematic sectional view of a vehicle headlight apparatus of a fourth preferred embodiment according to the present invention.

### DETAILED DESCRIPTION OF THE PREFERRED EMBODIMENTS

Before the invention is described in greater detail with reference to the accompanying embodiments, it should be noted herein that like elements are denoted by the same reference numerals throughout the disclosure.

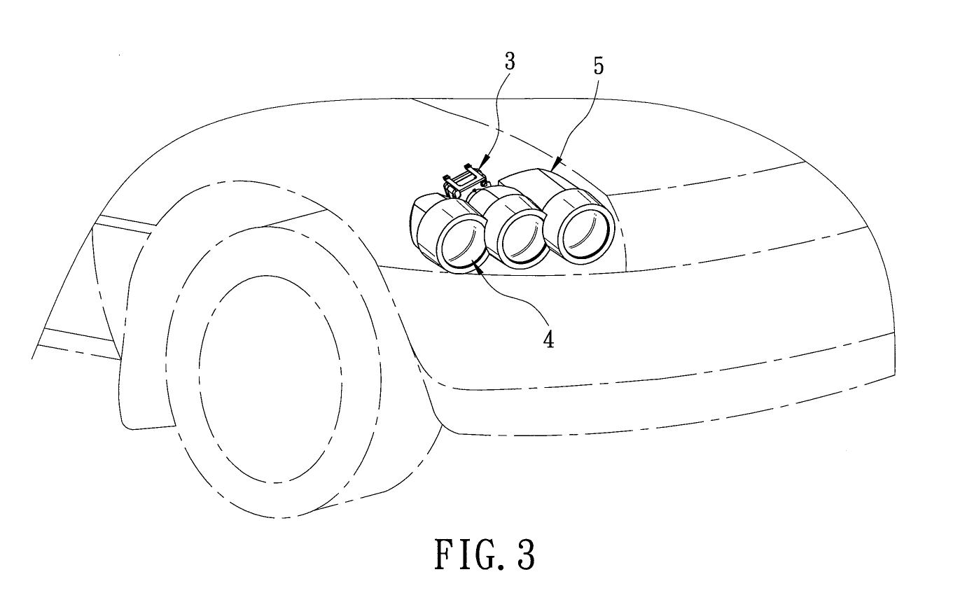

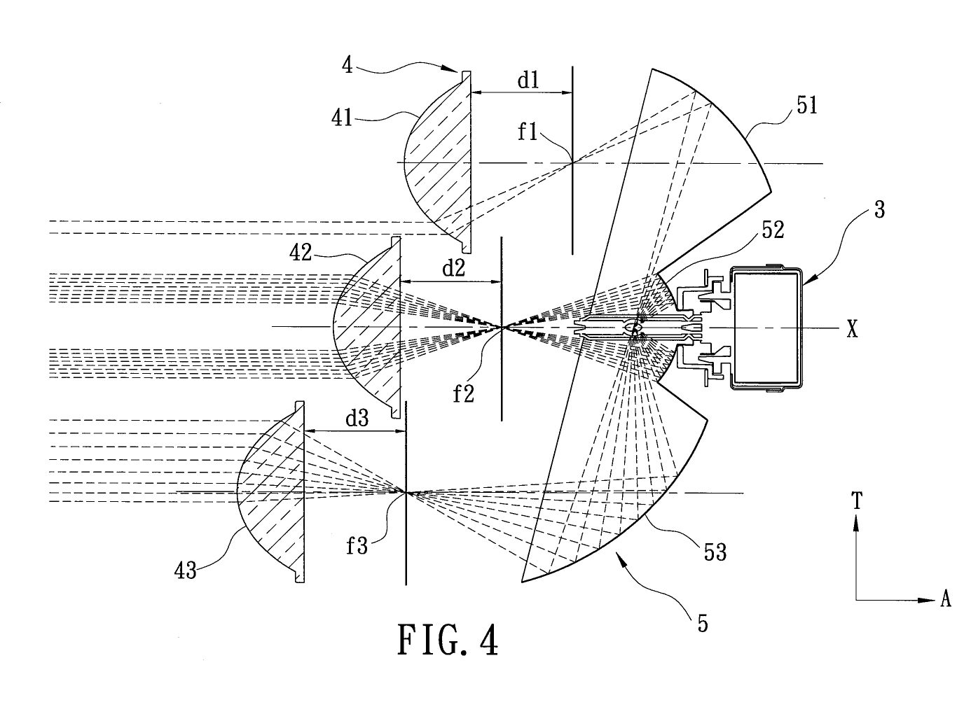

Referring to FIGS. 3 and 4, a first preferred embodiment of a vehicle headlight apparatus according to the present invention comprises a lamp device 3, a lens device 4, and a reflector unit 5.

The lamp device 3 has an optical axis (X) and generates light beams. In this preferred embodiment, the lamp device 3 is a high pressure gas discharge lamp.

The lens device 4 has three lenses 41, 42, 43 that are disposed in front of the lamp device 3 and that have equal focal distances d1, d2, d3. The focal points f1, f2, f3 of the lenses 41, 42, 43 located respectively behind the lenses 41, 42, 43 are spaced apart from each other along an axial direction (A) parallel to the optical axial (X), and along a transverse direction (T) perpendicular to the optical axis (X). The lenses 41, 42, 43 are also spaced apart from each other along the axial direction (A).

The reflector unit 5 has three reflecting surfaces 51, 52, 53. Any two adjacent ones of the reflecting surfaces 51, 52, 53 are spaced apart from each other along the transverse direction (T). The reflecting surfaces 51, 52, 53 reflect the light beams generated by the lamp device 3, and face respectively the lenses 41, 42, 43. In this preferred embodiment, the lenses 41, 42, 43 are convex lenses. Each of the reflecting surfaces 51, 52, 53 is a parabolic surface.

The light beams reflected from each of the reflecting surfaces 51, 52, 53 intersect at the focal point f1, f2, f3 of a corresponding one of the lenses 41, 42, 43, and are subsequently transmitted into the lenses 41, 42, 43 so that the light beams are parallel after they pass through the corresponding one of the lenses 41, 42, 43.

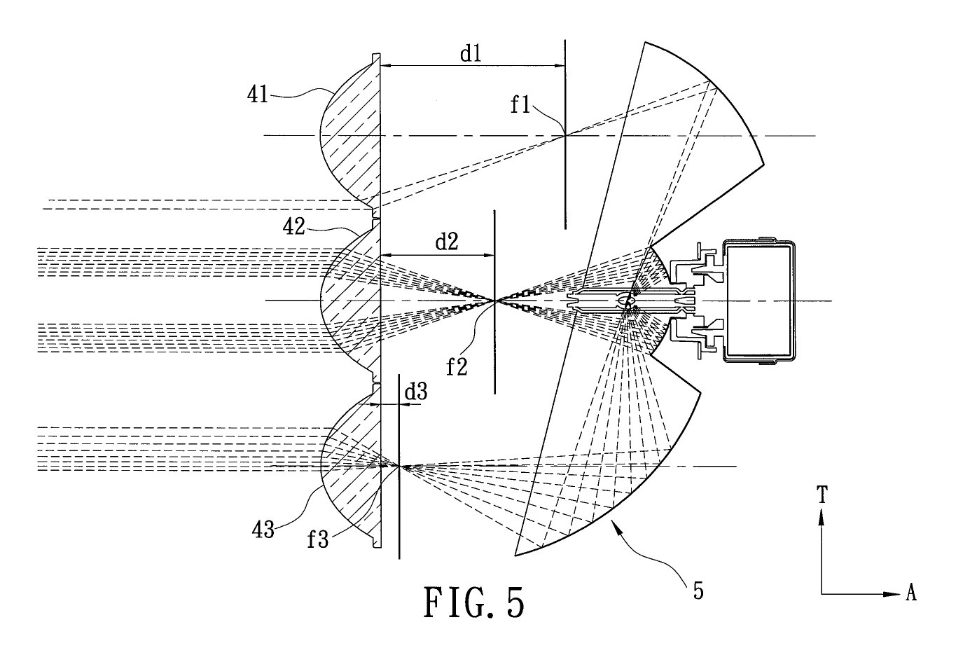

As shown in FIG. 5, a second preferred embodiment of the vehicle headlight apparatus according to the present invention has a structure similar to that of the first embodiment. The main difference between this embodiment and the first embodiment resides in the following. The lenses 41, 42, 43 have different focal distances d1, d2, d3, and the focal points f1, f2, f3 of the lenses 41, 42, 43 are spaced apart from each other along the axial direction (A). The lenses 41, 42, 43 are arranged along the transverse direction (T). The second preferred embodiment has the same advantages as those of the first preferred embodiment.

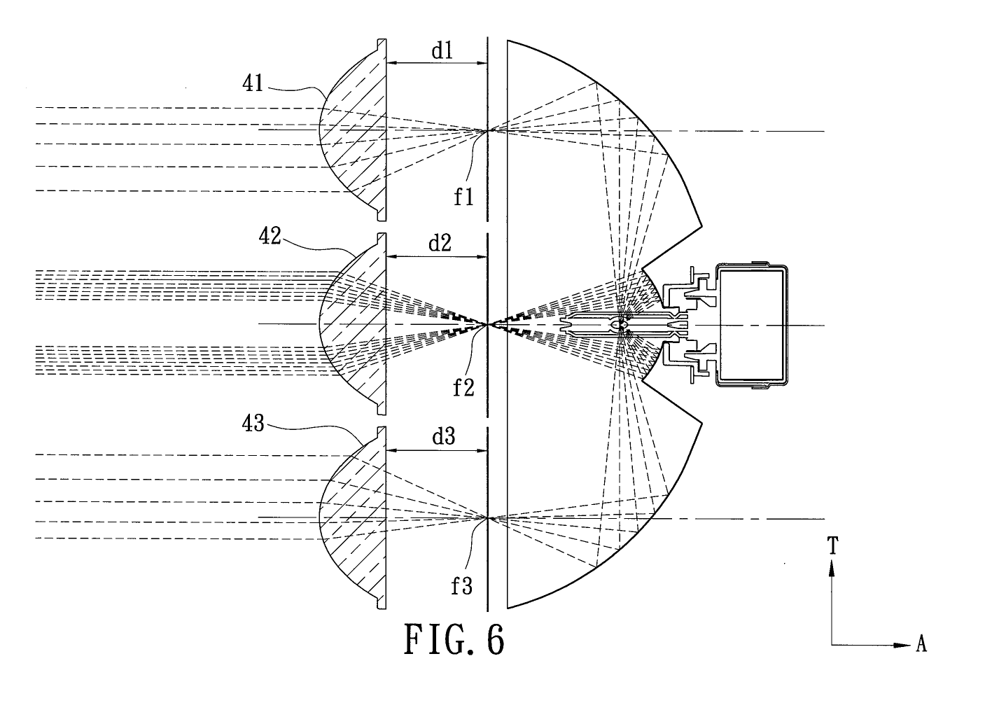

As shown in FIG. 6, a third preferred embodiment of the vehicle headlight apparatus according to the present invention has a structure similar to that of the first embodiment. The main difference between this embodiment and the first embodiment resides in the following. The lenses 41, 42, 43 have equal focal distances d1, d2, d3, and are arranged along the transverse direction (T), and the focal points f1, f2, f3 of the lenses 41, 42, 43 are also arranged along the transverse direction (T). The third preferred embodiment has the same advantages as those of the first preferred embodiment.

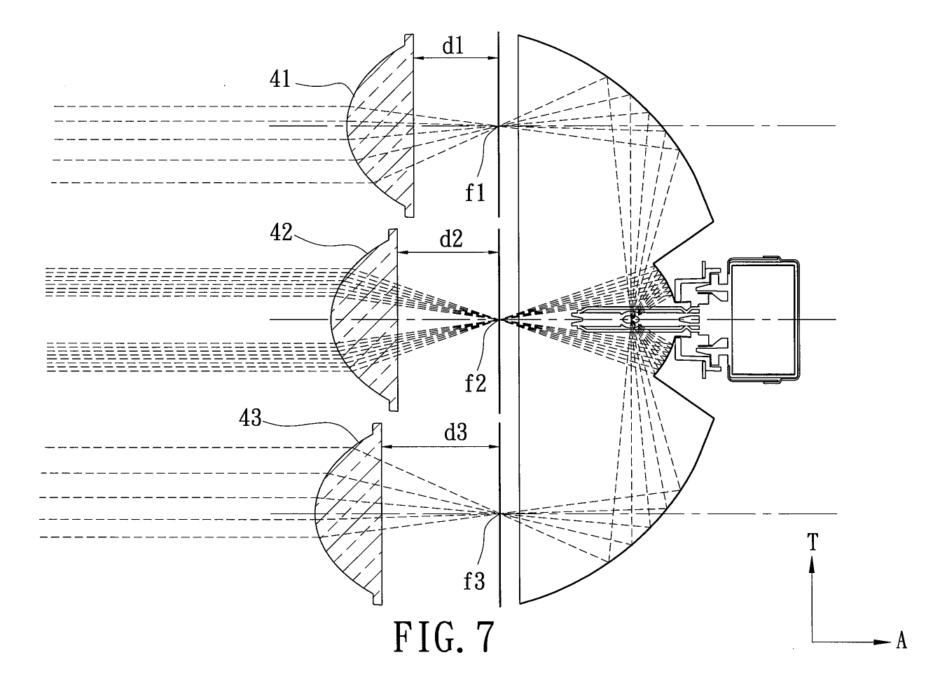

As shown in FIG. 7, a fourth preferred embodiment of the vehicle headlight apparatus according to the present invention has a structure similar to that of the first embodiment. The main difference between this embodiment and the first embodiment resides in the following. The lenses 41, 42, 43 have different focal distances d1, d2, d3, and the focal points f1, f2, f3 of the lenses 41, 42, 43 are arranged along the transverse direction (T). The fourth preferred embodiment has the same advantages as those of the first preferred embodiment.

To sum up, the advantages of the vehicle headlight apparatus according to the present invention are as follows. In the present invention, although only one lamp device 3 and only one reflecting unit 5 are employed by the vehicle headlight apparatus, the arrangement of the reflecting surfaces 51, 52, 53 and the lenses 41, 42, 43 provides a broader illumination area than the conventional vehicle headlight 1. The light beams generated by the lamp device 3 are reflected from the reflecting surfaces 51, 52, 53, intersect at the focal points f1, f2, f3 of the lenses 41, 42, 43, and are subsequently transmitted into the lenses 41, 42, 43, so that the light beams are parallel after they pass through the lenses 41, 42, 43. Therefore, the light beams are not be focused in front of the lens device 4 so as to prevent occurrence of glare, thus ensuring driving safety of oncoming drivers.

While the invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A vehicle headlight apparatus comprising:
a lamp device having an optical axis and generating light beams;
a lens device having a plurality of lenses disposed in front of said lamp device; and
a reflector unit having a plurality of reflecting surfaces, any two adjacent ones of which are spaced apart from each other along a transverse direction perpendicular to said optical axis, said reflecting surfaces reflecting the light beams generated by said lamp device and facing respectively said lenses;
wherein the light beams reflected from each of said reflecting surfaces intersect at a focal point of a corresponding one of said lenses, and are subsequently transmitted into said lenses so that the light beams are parallel after they pass through the corresponding one of said lenses.

2. The vehicle headlight apparatus as claimed in claim 1, wherein said lamp device is a high pressure gas discharge lamp.

3. The vehicle headlight apparatus as claimed in claim 1, wherein each of said reflecting surfaces is a parabolic surface.

4. The vehicle headlight apparatus as claimed in claim 1, wherein said lenses have equal focal distances, and are arranged along the transverse direction, and said focal points of said lenses are also arranged along the transverse direction.

5. The vehicle headlight apparatus as claimed in claim 1, wherein said lenses have different focal distances, and said focal points of said lenses are arranged along the transverse direction.

6. The vehicle headlight apparatus as claimed in claim 1, wherein said lenses have equal focal distances, and said focal points of said lenses are spaced apart from each other along an axial direction parallel to said optical axis, said lenses being also spaced apart from each other along the axial direction.

7. The vehicle headlight apparatus as claimed in claim 1, wherein said lenses have different focal distances, and said focal points of said lenses are spaced apart from each other along an axial direction parallel to said optical axis, said lenses being arranged along the transverse direction.

8. The vehicle headlight apparatus as claimed in claim 7, wherein said lenses are convex lenses.
